(19) United States
(12) Patent Application Publication
(10) Pub. No.: US 2024/0184959 A1
(43) Pub. Date: Jun. 6, 2024

(54) SEWAGE PIPE NETWORK HYDRAULIC MODEL BUILDING METHOD BASED ON THREE-DIMENSIONAL GEOGRAPHIC INFORMATION

(71) Applicant: Zhejiang University, Hangzhou (CN)

(72) Inventors: Feifei Zheng, Hangzhou, Zhejiang (CN); Yueyi Jia, Hangzhou (CN); Qingzhou Zhang, Hangzhou (CN)

(21) Appl. No.: 18/411,188

(22) Filed: Jan. 12, 2024

Related U.S. Application Data
(63) Continuation of application No. PCT/CN2021/112928, filed on Aug. 17, 2021.

(30) Foreign Application Priority Data
Jul. 12, 2021 (CN) 202110786193.8
Jul. 12, 2021 (CN) 202110786201.9

(51) Int. Cl. G06F 30/28; G06F 30/18; G06F 111/10; G06F 113/08; G06F 113/14

(52) U.S. Cl. CPC G06F 30/28; G06F 30/18; G06F 2111/10; G06F 2113/08; G06F 2113/14

(57) ABSTRACT

Disclosed is a sewage pipe network hydraulic model building method based on three-dimensional geographic information. According to the method, physical corresponding relation between each manhole node of the sewage pipe network and surrounding buildings is obtained through the three-dimensional geographic information, the population of the sewage pipe network is estimated as prior information according to the corresponding relation, an optimization algorithm is used to determine the total influent time series of all manhole nodes in a region based on the population proportion, and flow fluctuation coefficient for each manhole node is optimized and calculated, such that the influent time series of each manhole node is determined, and the sewage pipe network hydraulic model is built accurately. The present disclosure further provides a method that uses the population data to replace the pipe length/catchment area data as the prior information for sewage pipe network flow check.

### CROSS REFERENCE TO RELATED APPLICATIONS

The present application is a Continuation Application of PCT Application No. PCT/CN2021/112928 filed on Aug. 17, 2021, which claims the benefit of Chinese Patent Application Nos. 202110786193.8 and 202110786201.9 filed on Jul. 12, 2021. All the above are hereby incorporated by reference in their entirety.

### TECHNICAL FIELD

The present disclosure belongs to the field of municipal sewage pipe networks of the municipal engineering, and particularly relates to a sewage pipe network hydraulic model building method based on three-dimensional geographic information.

### BACKGROUND

An urban sewage pipe network constitutes an important urban infrastructure for maintaining urban water environment and preventing the spread of diseases, and is crucial to guaranteeing urban public health and ecological health. In recent years, with the increasing population and accelerating urbanization, spatial scale and structural complexity of sewage pipe networks have become intensified significantly, and relevant systems are aged, which make the sewage pipe network being subjected to many problems in the operation and management process, and some typical problems thereof include pipe blockage, pipe leakage, rainwater and sewage misconnection, illegal discharge, sewage overflow, etc. These problems seriously pollute urban water environment, threaten urban water safety, and affect normal operation of downstream sewage treatment plants, and they are the fundamental cause of urban black and odorous water bodies and need to be solved urgently.

One method to solve the above problems is to establish an online monitoring system of the sewage pipe networks, and install sensors at key positions of the sewage pipe networks to monitor water depth and flow in real time, so that abnormal events such as blockage, leakage and illegal discharge can be effectively alerted and positioned. However, monitoring sensors of sewage systems are often costly and difficult to maintain, therefore, they are unable to cover the entire sewage pipe network with high density in a large scale, but only to provide abnormal alarms and diagnoses in a small area covered by monitoring points instead. Therefore, the method usually needs to be combined with an accurate sewage pipe network model, and determine whether abnormalities have occurred by simulating dynamic behavior of hydraulic variables and comparing the dynamic behavior with limited monitoring point data. The sewage pipe network model can also simulate hydraulic parameters of any position of a pipe network, so as to predict changes in water depth and flow at non-monitoring points, and help diagnose and locate abnormalities at the non-monitoring points.

The accuracy of a sewage pipe network hydraulic model will greatly affect carly warning performance of an online monitoring system in the method, which is a key constituent of the online monitoring system. In order to ensure the accuracy of the hydraulic model, flow data with high spatial and temporal resolution are needed to check the model, which is difficult to obtain in actual projects. In order to solve this problem, an offline calibration method is commonly used, which uses limited monitoring data to calculate and determine the flow time series of each manhole node. In addition, assuming that the overall flow during the same period of time of different days should be generally approximate, some researches shorten calculation time by using an expected value of a single-day flow time series to represent the flow changes of different days, but the method has a great defect, that is, it fails to take into account the multi-solution nature of the sewage flow time series obtained by optimization, more specifically, the method can only ensure simulated values at the monitoring points are approximate to monitoring values, but cannot ensure whether simulated values at the non-monitoring points are approximate to the real situation, because different combinations of the simulated values at the non-monitoring points can ensure that results of the monitoring points are consistent, it is difficult to determine a specific and unique flow set capable of reflecting real hydraulic condition of the pipe network, and the efficiency and accuracy of the online monitoring system of the sewage pipe network are seriously influenced.

A common way to solve the multi-solution problem is to use prior information to constrain the check results, while the traditional method usually distributes the flow according to pipeline length and catchment area, because a longer pipeline and a larger catchment area always result in the influent of more sewage. However, such presetting does not necessarily correspond to the actual situation. For example, although a sewage pipeline for transmission is long, its influent of sewage is very little due to low density of surrounding users; while pipeline erected in areas with high density of population, in spite of very short, suffer a large volume of sewage. Similarly, a larger catchment area may have less populated buildings, resulting in a lower volume of sewage. Therefore, if the pipe length and the catchment area are directly used as prior information to check the sewage pipe network model, the flow check results may deviate from reality, thus resulting in false alarm and missing report of the monitoring system. A more reasonable method is to use the corresponding population as prior information, because the population, that is, the number of users, is closely associated with the sewage discharge volume, but the population data is more difficult to obtain than the pipeline length, and has wide fluctuations, making it hard to be directly applied to the actual projects.

### SUMMARY

In order to overcome the defects in the background art and effectively solve the multi-solution problem arising from the flow check of a sewage pipe network, the present disclosure firstly provides a sewage pipe network hydraulic model building method based on three-dimensional geographic information, specifically, dividing the sewage pipe network into regions according to the three-dimensional geographic information, estimating the population corresponding to buildings in a sub-region, and distributing the population to the nearest manhole mode of the sewage pipe network, so that the prior information of the population corresponding to manhole node is obtained; then using an optimization algorithm to determine the total influent time series of all manhole nodes in the sub-region based on the population proportion; and finally optimizing and calculating the flow adjustment coefficient for each manhole based on the determined total influent time series, so that the influent time series of each manhole node is determined, and the sewage pipe network hydraulic model is built accurately. Under the condition that real-time data are hard to be obtained in large quantities, the present disclosure uses the easy-to-obtain three-dimensional geographic information to solve the multi-solution problem arising from the flow check of a sewage pipe network in an innovative manner, and builds an accurate sewage pipe network hydraulic model on the premise of very limited parameters, thereby providing key technical support for carly warning and diagnosis of abnormalities, if any, in the sewage pipe network.

Specifically, technical problems to be solved by the present disclosure are: a sewage pipe network hydraulic model building method based on three-dimensional geographic information is provided. By means of the method, physical corresponding relation between cach manhole node of the sewage pipe network and surrounding buildings is obtained through the three-dimensional geographic information, the population of the sewage pipe network is estimated as prior information according to the corresponding relation, an optimization algorithm is used to determine the total influent time series of all manhole nodes in a region based on the population proportion, and flow fluctuation coefficient for each manhole node is optimized and calculated, such that the influent time series of each manhole node is determined, and the sewage pipe network hydraulic model is built accurately, thereby providing key technical support for early warning and diagnosis of abnormalities in the sewage pipe network.

In order to achieve the above objective, the present disclosure provides the following technical solution:
the present disclosure provides a sewage pipe network hydraulic model building method based on three-dimensional geographic information, and the method includes the following steps:
(1) estimating the total population P(h) corresponding to a sewage manhole node h;
(2) checking the total sewage influent qₙ(tₐ) of a sewage pipe network hydraulic model subsystem at each moment tₐ;
(3) checking a sewage flow adjustment coefficient kₕ of each manhole node h of the sewage pipe network hydraulic model; and
(4) realizing accurate building of the sewage pipe network hydraulic model and simulation of hydraulic parameters of the sewage pipe network.

Further, the step (1) specifically includes:
(11) preliminarily building a sewage pipe network hydraulic model based on a topological structure of the sewage pipe network and physical information of component members thereof;
(12) further establishing the physical mapping relation between the manhole nodes h of the sewage pipe network hydraulic model and surrounding buildings based on the three-dimensional geographic information, and mapping each building the manhole node h with the closest spatial distance according to the Euclidean distance formula, with the specific formula as follows:

d(r,h)=\sqrt{(xₕ−xᵣ)²+(yₕ−yᵣ)²+(zₕ−zᵣ)²} Formula 1-1
where (xᵣ, yᵣ, zᵣ) is a three-dimensional coordinate of a plane geometric center coordinate system based on a bottom surface of a building;
(xₕ, yₕ, zₕ) is a three-dimensional coordinate of a coordinate system based on the manhole mouth of the manhole node h;
(13) dividing all buildings into residential buildings r and public buildings u according to the functionality, and estimating the total population of all residential buildings r corresponding to the manhole node h, with the specific formula as follows:

$$P ( h ) = {A}_{r} {\sum }_{r = 1}^{{R}_{h}} η \times {V}_{r} ( h ) \qquad Formula 1 - 2$$

where P(h) is the total population estimate associated with the manhole node h;
Vᵣ(h) is the volume (in m³) of the residential building r associated with the manhole node h;
Rₕ is the number of all residential buildings r associated with the manhole node h;
η is the average population per building volume (in np/m³);
Aᵣ is the occupancy rate of the residential building r;
(14) estimating the sewage discharge volume of all public buildings u corresponding to the manhole node h, with the specific formula as follows:

DSᵤ(t)=TFᵤ(t)×WSᵤ(t) Formula 1-3
where DSᵤ(t) is the sewage discharge volume of the public building u at a moment t;
WSᵤ(t) is the water consumption of the public building u at the moment t; and
TFᵤ(t) is a conversion coefficient between water consumption and sewage discharge volume at the moment t.

Further, the component members include a sewage pipeline, manhole nodes h and sewage outlets.

Preferably, the topological structure of the sewage pipe network and the physical information of the component members can be obtained by a geographic information system (GIS).

Further, the step (2) specifically includes:
(21) dividing the sewage pipe network into N subsystems based on the positions of the installed N sewage flow meters, wherein each subsystem has a unique sewage flow meter corresponding to the subsystem area, and N flow monitoring points are provided, wherein N only represents the number and has no practical significance;
(22) establishing a single-objective function of the subsystem flow optimization, with the specific formula as follows:
minimizing:

$$Formula 1 - 4$$

$$F ( Q ) = {\sum }_{t = {T}_{w}}^{{T}_{e}} ( {\sum }_{i = 1}^{M} {[ g ( {w}_{i}^{o} ( t ) ) - g ( {w}_{i}^{s} ( t ) ) ]}^{2} + {\sum }_{n = 1}^{N} {[ g ( {f}_{n}^{o} ( t ) ) - g ( {f}_{n}^{s} ( t ) ]}^{2} )$$

$$where Q = [ \begin{matrix}{q}_{1} ( Δ t ) , {q}_{1} ( 2 Δ t ) , ... , {q}_{1} ( T ) \\ {q}_{2} ( Δ t ) , {q}_{2} ( 2 Δ t ) , ... , {q}_{2} ( T ) \\ ... \\ {q}_{N} ( Δ t ) , {q}_{N} ( 2 Δ t ) , ... , {q}_{N} ( T )\end{matrix} ] ; \qquad Formula 1 - 5$$

$$Formula 1 - 6$$

$${MI}_{h} ( {t}_{a} ) = \{ \begin{matrix}\frac{{q}_{n} ( {t}_{a} ) \times P ( h )}{{\sum }_{h = 1}^{{H}_{n}} P ( h )} , h ∈ {H}_{n} , & when the manhole h is associated \\ & with the residential building \\ {\sum }_{u = 1}^{h ( u )} {DS}_{u} ( {t}_{a} ) , & when the manhole node h is \\ & associated with the public building\end{matrix}$$

$${F}_{m} ( MI ( {t}_{a} ) ) = [ {W}^{s} ( {t}_{a} ) ; {f}^{s} ( {t}_{a} ) ] = [ {w}_{1}^{s} ( {t}_{a} ) , {w}_{2}^{s} ( {t}_{a} ) , ... , {w}_{M}^{s} ( {t}_{a} ) ; {f}_{1}^{s} ( {t}_{a} ) , {f}_{2}^{s} ( {t}_{a} ) , ... , {f}_{N}^{s} ( {t}_{a} ) ] \qquad Formula 1 - 7$$

where MIₕ(tₐ) is the sewage influent of a single manhole node h at the moment tₐ;
MI(tₐ) is the sewage influent of all manhole nodes at the moment tₐ;
qₙ(T) is the total sewage influent of all manhole nodes of the n^{th} subsystem at the moment T, where N is 1,2,3, and N;
Hₙ are all manhole nodes associated with the residential buildings in the subsystem;
Fₘ(MI(tₐ)) is a hydraulic simulation result of the sewage pipe network based on MI(tₐ), including the liquid level of a manhole node and the flow rate of a sewage pipe;
Tₑ represents the end time of the liquid levels and flow monitoring values used for checking the sewage pipe network hydraulic model;
T_{w} represents the starting time for checking the sewage pipe network hydraulic model;
tₐ is the check moment selected by the sewage pipe network hydraulic model;
Q is a decision variable matrix which represents a time series matrix of the total sewage influent rate of each subsystem;
i=1, 2, . . . , M, where M represents the number of liquid level monitoring points;
n=1, 2, . . . , N, where N represents the number of flow monitoring points corresponding to the subsystems one by one;
F(Q) is an objective function value with Q as a decision variable;
T is a simulation period of the sewage pipe network hydraulic model, such as 24 hours;
Δt is a calculation time accuracy of the sewage pipe network hydraulic model, such as 30 minutes;
wᵢ^{s}(tₐ) and fₙ^{s}(tₐ) respectively represent simulated liquid level values at a node i of the manhole node with liquid level monitoring and simulated flow values of a sewage pipe n with flow monitoring at the moment tₐ;
wᵢ^{o}(t) and fₙ^{o}(t) respectively represent monitoring values at a node i of the manhole node with liquid level monitoring and monitoring values of a sewage pipe n with flow monitoring at the moment;
w^{s}(tₐ) and f^{s}(tₐ) respectively represent a collection of the simulated liquid level values at the node i of the manhole node with liquid level monitoring and a collection of the simulated flow values of the sewage pipe with flow monitoring at the moment tₐ;
h(u) represents the total number of public buildings associated with the sewage manhole node h;
g( ) is a linear conversion function for converting liquid level and flow into the same magnitude, defined as:

$$g ( x ) = \frac{x - {x}_{min}}{{x}_{max} - {x}_{min}} \qquad Formula 1 - 8$$

in the formula, x represents an observed value or a simulated value of a liquid level and/or a flow monitoring point;
xₘᵢₙ and xₘₐₓ represent an upper limit and a lower limit of the observed value or the simulated value of a liquid level and/or a flow monitoring point; and
(23) adopting the genetic algorithm to solve a single-objective optimization model F(Q) of the subsystem flow optimization, and obtaining an optimal total sewage influent time series matrix Q of each subsystem.

Further, the step (3) specifically includes:
(31) establishing the single-objective function for flow optimization of the manhole node of the sewage pipe network hydraulic model, with the specific formula as follows:
minimizing:

$$F ( K ) = {\sum }_{t = {T}_{w}}^{{T}_{e}} ( {\sum }_{i = 1}^{M} {[ g ( {w}_{i}^{o} ( t ) ) - g ( {w}_{i}^{s} ( t ) ) ]}^{2} + {\sum }_{n = 1}^{N} {[ g ( {f}_{n}^{o} ( t ) ) - g ( {f}_{n}^{s} ( t ) ]}^{2} ) \qquad Formula 1 - 9$$

$${MI}_{h}^{u} ( {t}_{a} ) = {k}_{h} \frac{{q}_{n} ( {t}_{a} ) \times P ( h )}{{\sum }_{h = 1}^{{H}_{n}} P ( h )} , \\ the manhole node h is associated with the residential buildings \qquad Formula 1 - 10$$

$${F}_{m} ( {MI}^{u} ( {t}_{a} ) ) = [ {W}^{s} ( {t}_{a} ) ; {f}^{s} ( {t}_{a} ) ] \qquad Formula 1 - 11$$

$${k}_{h} ∈ [ {k}_{min} , {k}_{max} ] \qquad Formula 1 - 12$$

where K=[k₁, k₂, . . . k_{H}]^{T} is a decision variable;
F(K) is an objective function value with K as a decision variable;
kₕ represents the flow adjustment coefficient for the manhole node h;
MIₕ^{u}(tₐ) is the sewage influent of the single manhole node h at the moment tₐ after being adjusted with kₕ;
MI^{u}(tₐ)is the sewage influent of all manhole nodes at the moment tₐ after being adjusted with K;
kₘᵢₙ and kₘₐₓ represent the minimum value and the maximum value allowed by the flow adjustment coefficient for the manhole node; and
preferably kₘᵢₙ=0.85, and kₘₐₓ=1.15.
(32) adopting the evolutionary algorithm to solve a single-objective optimization model F(K) of the flow optimization of the manhole nodes in the sewage pipe network hydraulic model, and obtaining an optimal sewage flow adjustment coefficient kₕ for each manhole node h.

Further, the step (4) specifically includes:
(41) obtaining the total population corresponding to the manhole nodes h as prior information through the step (1) according to the three-dimensional geographic information, and preliminarily checking the total sewage influent of the sewage pipe network subsystem according to the step (2);
(42) checking the sewage flow adjustment coefficient kₕ of each manhole node based on the total sewage influent of the subsystem obtained in the step (41) according to the step (3), and determining a single-day influent time series MIₕ^{u}(tₐ) of each manhole node; and
(43) running the sewage pipe network hydraulic model to simulate sewage pipe network hydraulic parameter values.

Preferably, the simulated sewage pipe network hydraulic parameter values include simulated liquid level, flow rate and other hydraulic parameters.

The present disclosure has the following beneficial effects:
(1) the present disclosure provides a method that uses the population data to replace the pipe length/catchment area data as the prior information for sewage pipe network flow check, which more reasonably solves the common multi-solution problem in the existing simulation technology of the sewage pipe network, and makes the sewage pipe network flow check results more accurate in spite of having no sufficient monitoring data;
(2) the present disclosure provides a method for estimating the corresponding population of the manholes by using three-dimensional geographic information for the first time, the corresponding population is calculated by estimating the building volume based on the geographic information, the physical connection between sewage manhole nodes and surrounding buildings is established, and the population of the building is mapped to the manhole nodes, such that relatively accurate prior information is obtained, and the problem of serious shortage of sewage pipe network data is effectively solved;
(3) the two-step optimization method provided in the present disclosure can optimize and check the total influent of the sewage pipe network and the adjustment coefficient of a single manhole node, which simplifies the complexity of calculation and makes the hydraulic check process of the sewage pipe network more efficient; and
(4) being capable of optimizing the conventional sewage pipe network static check and offline simulation method, mitigating the difficulty in acquiring check data, and improving the accuracy of the check data, the method provided in the present disclosure becomes an important supplement to the field of urban drainage pipe network management research, provides an important technical support for the management of the sewage pipe network system, and has good values for popularization and practical engineering application.

### BRIEF DESCRIPTION OF THE DRAWINGS

FIG. 1 is a schematic diagram of an overall flow of the present disclosure.

FIG. 2 is a conceptual diagram of physical connection between manholes and buildings.

FIG. 3 is a schematic diagram of a method for estimating the population corresponding to a building by using a three-dimensional map.

FIG. 4 is a schematic diagram of a sewage pipe network and surrounding building zoning.

FIG. 5 is a layout diagram of a sewage pipe network system and monitoring points of BKN.

FIG. 6 is a layout diagram of a sewage pipe network system and monitoring points of an example XZN.

FIG. 7 is a graph of a density distribution of the population associated with manhole nodes.

FIG. 8 is a comparison diagram of simulated values of the flow at monitoring points of an example BKN between the method in the present disclosure and the conventional method.

FIG. 9 is a diagram of a relative error distribution of the flow at monitoring points of an example BKN between the method in the present disclosure and the conventional method.

FIG. 10 is a diagram of comparison of simulated values of the liquid level at monitoring points of an example BKN between the method in the present disclosure and the conventional method.

FIG. 11 is a diagram of a relative error distribution of the liquid level at monitoring points of an example BKN between the method in the present disclosure and the conventional method.

FIG. 12 is a comparison diagram of simulated values of the flow at monitoring points of an example XZN between the method in the present disclosure and the conventional method.

FIG. 13 is a diagram of a relative error distribution of the flow at monitoring points of an example XZN between the method in the present disclosure and the conventional method.

FIG. 14 is a comparison diagram of simulated values of the liquid level at monitoring points of an example XZN between the method in the present disclosure and the conventional method.

FIG. 15 is a diagram of a relative error distribution of the liquid level at monitoring points of an example XZN between the method in the present disclosure and the conventional method.

FIG. 16 is a diagram of comparison between observed values and simulated values of the liquid level at monitoring points of an example BKN on a single day.

FIG. 17 is a diagram of comparison between observed values and simulated values of the flow at monitoring points of an example XZN on a single day.

FIG. 18 is a diagram of comparison of simulated values and observed values of the flow of the corresponding water supply nodes at non-monitoring points of an example BKN between the method in the present disclosure and the conventional method.

FIG. 19 is a diagram of comparison of simulated values and observed values of the flow of the corresponding water supply nodes at non-monitoring points of an example BKN between the method in the present disclosure and the conventional method.

FIG. 20 is a diagram of comparison of simulated values and observed values of the flow of the corresponding water supply nodes at non-monitoring points of an example XZN between the method in the present disclosure and the conventional method.

FIG. 21 is a diagram of comparison of observed values of the flow of the corresponding water supply nodes at non-monitoring points of an example XZN between the method in the present disclosure and the conventional method.

FIG. 22 is a diagram illustrating the density distribution of a conversion coefficient TF between water consumption and sewage discharge volume in an example BKN.

FIG. 23 is a diagram illustrating the density distribution of a conversion coefficient TF between water consumption and sewage discharge volume in an example XZN.

### DETAILED DESCRIPTIONS OF THE EMBODIMENTS

The specific embodiments of the present disclosure will be described in detail below in conjunction with the accompanying drawings. It should be noted that the embodiments are merely specific elaboration of the present disclosure and should not be regarded as limitations of the present disclosure. The purpose of the embodiments is to enable those skilled in the art to better understand and reproduce the technical solutions of the present disclosure, and the scope of protection of the present disclosure should be subject to the scope defined by the claims.

The three-dimensional geographical information in the present disclosure can be obtained according to a three-dimensional map simulating a place of actual implementation, and the three-dimensional map can be obtained from a geographical information database in the prior art.

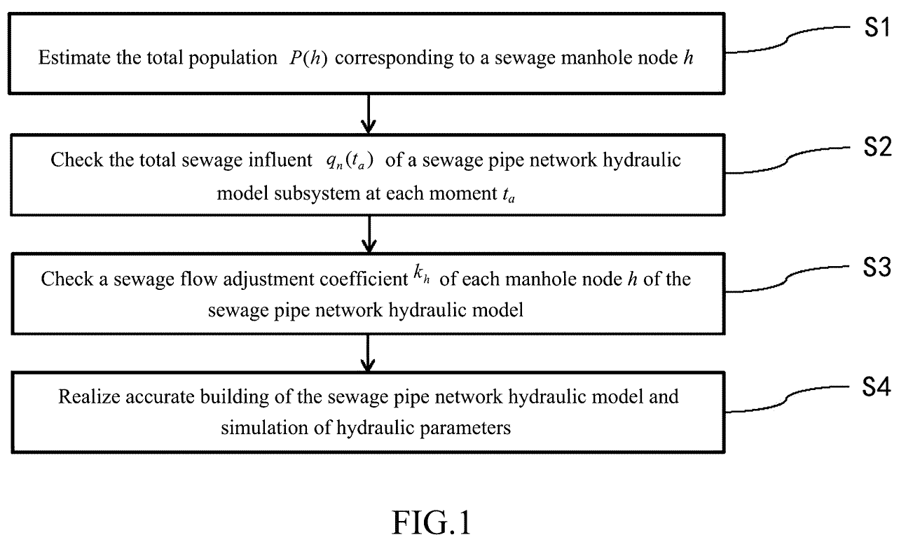

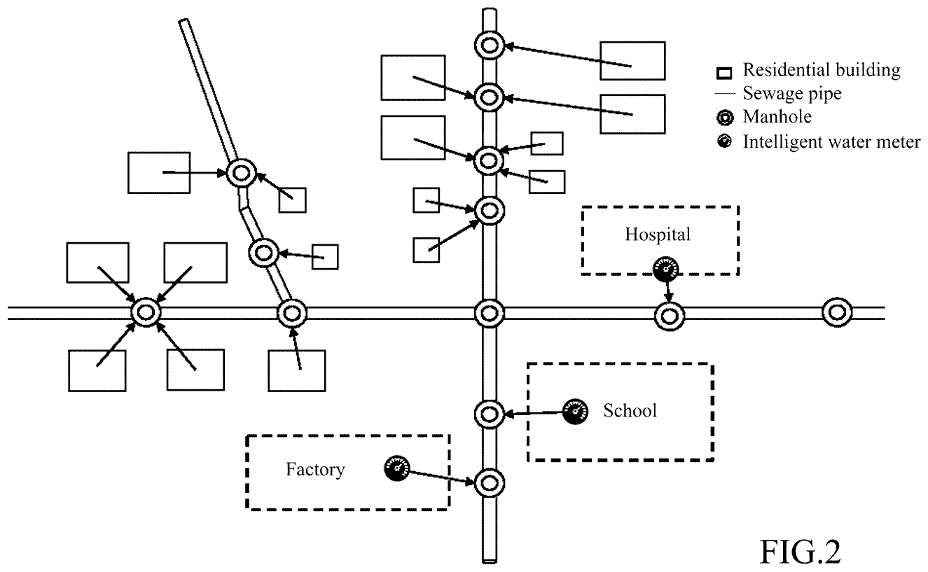

As shown in FIG. 1, the present disclosure provides a sewage pipe network hydraulic model building method based on three-dimensional geographic information, and the method includes the following steps:
S1, estimating the total population P(h) corresponding to a sewage manhole node h;
S11, preliminarily building a sewage pipe network hydraulic model based on a topological structure of the sewage pipe network and physical information of members thereof;
S12, further establishing the physical mapping relation between the manhole nodes h of the sewage pipe network hydraulic model and surrounding buildings based on the three-dimensional geographic information, as shown in FIG. 2, and mapping each building the manhole node h with the closest spatial distance according to the Euclidean distance formula, with the specific formula as follows:

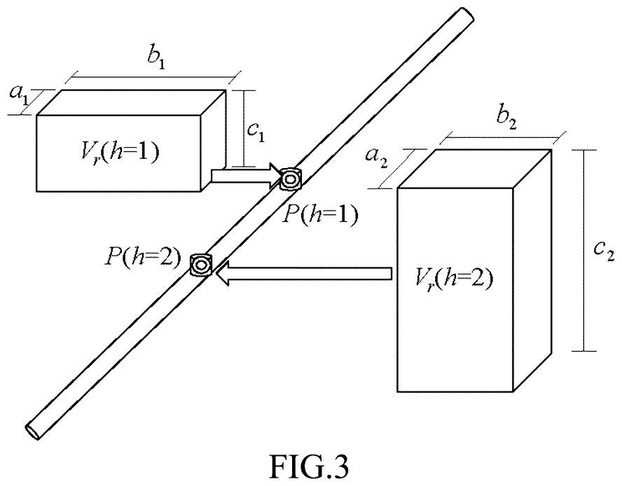

d(r,h)=\sqrt{(xₕ−xᵣ)²+(yₕ−yᵣ)²+(zₕ−zᵣ)²} Formula 1-1
where (xᵣ, yᵣ, zᵣ) is a three-dimensional coordinate of a plane geometric center coordinate system based on a bottom surface of a building;
(xₕ, yₕ, Zₕ)is a three-dimensional coordinate of a coordinate system based on the manhole mouth of the manhole node h;
S13, dividing all buildings into residential buildings r and public buildings u according to the functionality, and estimating the total population of all residential buildings r corresponding to the manhole node h, with the specific formula as follows:

$$P ( h ) = {A}_{r} {\sum }_{r = 1}^{{R}_{h}} η \times {V}_{r} ( h ) \qquad Formula 1 - 2$$

where P(h) is the total population estimate associated with the manhole node h;
Vᵣ(h) is the volume (in m³) of the residential building r associated with the manhole node h, and its value is calculated through a three-dimensional geographic information database, as shown in FIG. 3;

Rₕ is the number of all residential buildings r associated with the manhole node h;
η is the average population per building volume (in np/m³), and its value obtained from official census data or field sampling surveys;
Aᵣ is the occupancy rate of the residential building r and also obtained by the relevant local management department;
S14, estimating the sewage discharge volume of all public buildings u corresponding to the manhole node h, with the specific formula as follows:

DSᵤ(t)=TFᵤ(t)×WSᵤ(t) Formula 1-3
where DSu(t) is the sewage discharge volume of the public building u at a moment t;
WSᵤ(t) is the water consumption of the public building u at the moment t, and its value can be obtained in real time through the commonly installed intelligent water meter at present; and
TFᵤ(t) is a conversion coefficient between water consumption and sewage discharge volume at the moment t.

The component members include a sewage pipeline, manhole nodes h and a sewage outlet.

Preferably, the topological structure of the sewage pipe network and the physical information of the component members can be obtained by a geographic information system (GIS).

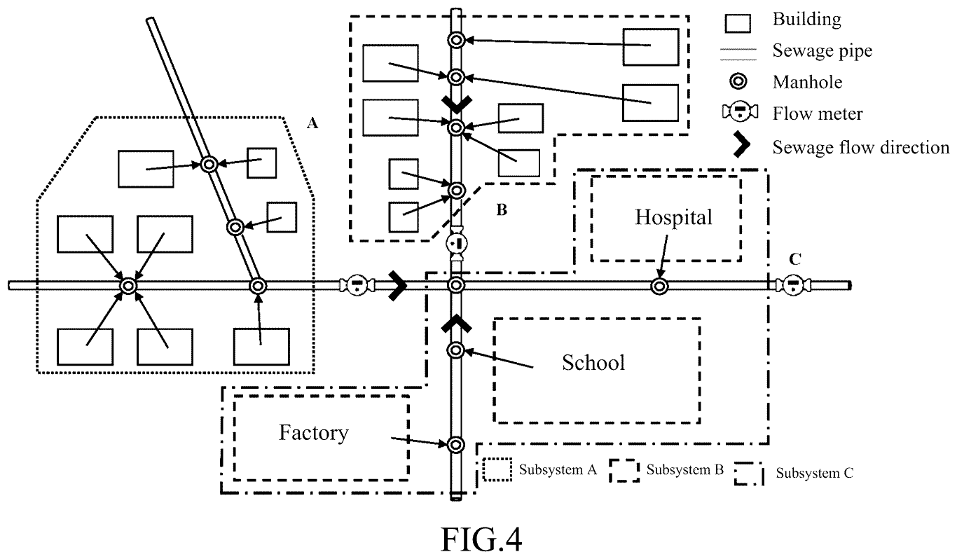

S2, checking the total sewage influent qₙ(tₐ) of a sewage pipe network hydraulic model subsystem at each moment tₐ;
S21, dividing the sewage pipe network into N subsystems based on the positions of the installed N sewage flow meters, and dividing a pipe network upstream the sewage flow meters into subsystem areas covered by the sewage flow meters, where each subsystem has a unique sewage flow meter corresponding to the subsystem area, as shown in FIG. 4, and N flow monitoring points are provided, where N only represents the number and has no practical significance;
S22, establishing a single-objective function of the subsystem flow optimization, with the specific formula as follows:
minimizing:

$$Formula 1 - 4$$

$$F ( Q ) = {\sum }_{t = {T}_{w}}^{{T}_{e}} ( {\sum }_{i = 1}^{M} {[ g ( {w}_{i}^{o} ( t ) ) - g ( {w}_{i}^{s} ( t ) ) ]}^{2} + {\sum }_{n = 1}^{N} {[ g ( {f}_{n}^{o} ( t ) ) - g ( {f}_{n}^{s} ( t ) ]}^{2} )$$

$$where Q = [ \begin{matrix}{q}_{1} ( Δ t ) , {q}_{1} ( 2 Δ t ) , ... , {q}_{1} ( T ) \\ {q}_{2} ( Δ t ) , {q}_{2} ( 2 Δ t ) , ... , {q}_{2} ( T ) \\ ... \\ {q}_{N} ( Δ t ) , {q}_{N} ( 2 Δ t ) , ... , {q}_{N} ( T )\end{matrix} ] ; \qquad Formula 1 - 5$$

$$Formula 1 - 6$$

$${MI}_{h} ( {t}_{a} ) = \{ \begin{matrix}\frac{{q}_{n} ( {t}_{a} ) \times P ( h )}{{\sum }_{h = 1}^{{H}_{n}} P ( h )} , h ∈ {H}_{n} , & when the manhole h is associated \\ & with the residential building \\ {\sum }_{u = 1}^{h ( u )} {DS}_{u} ( {t}_{a} ) , & when the manhole node h is \\ & associated with the public building\end{matrix}$$

$${F}_{m} ( MI ( {t}_{a} ) ) = [ {W}^{s} ( {t}_{a} ) ; {f}^{s} ( {t}_{a} ) ] = [ {w}_{1}^{s} ( {t}_{a} ) , {w}_{2}^{s} ( {t}_{a} ) , ... , {w}_{M}^{s} ( {t}_{a} ) ; {f}_{1}^{s} ( {t}_{a} ) , {f}_{2}^{s} ( {t}_{a} ) , ... , {f}_{N}^{s} ( {t}_{a} ) ] \qquad Formula 1 - 7$$

where MIₕ(tₐ) is the sewage influent of a single manhole node h at the moment tₐ;
MI(tₐ) is the sewage influent of all manhole nodes at the moment tₐ;
qₙ(T) is the total sewage influent of all manhole nodes of the n^{th} subsystem at the moment T, where Nis 1,2,3, and N;
Hₙ are all manhole nodes associated with the residential building in the subsystem;
Fₘ(MI(tₐ)) is a hydraulic simulation result of the sewage pipe network based on MI(tₐ), including the liquid level of a manhole node and the flow rate of a sewage pipe;
Tₑ represents the end time of the liquid levels and flow monitoring values used for checking the sewage pipe network hydraulic model;
T_{w} represents the starting time for checking the sewage pipe network hydraulic model;
tₐ is the check moment selected by the sewage pipe network hydraulic model;
Q is a decision variable matrix which represents a time series matrix of the total sewage influent rate of each subsystem;
i=1, 2, . . . , M, where M represents the number of liquid level monitoring points;
n=1, 2, . . . , N, where N represents the number of flow monitoring points corresponding to the subsystems one by one;
F(Q) is an objective function value with Q as a decision variable;
T is a simulation period of the sewage pipe network hydraulic model, such as 24 hours;
Δt is a calculation time accuracy of the sewage pipe network hydraulic model, such as 30 minutes;
wᵢ^{s}(tₐ) and fₙ^{s}(tₐ) respectively represent simulated liquid level values at a node i of the manhole node with liquid level monitoring and simulated flow values of a sewage pipe n with flow monitoring at the moment tₐ;
wᵢ^{o}(t) and fₙ^{o}(t) respectively represent monitoring values at a node i of the manhole node with liquid level monitoring and monitoring values of a sewage pipe n with flow monitoring at the moment t;
w^{s}(tₐ) and f^{s}(tₐ) respectively represent a collection of the simulated liquid level values at the node i of the manhole node with liquid level monitoring and a collection of the simulated flow values of the sewage pipe with flow monitoring at the moment tₐ;
h(u) represents the total number of public buildings associated with the sewage manhole node h;
g( ) is a linear conversion function for converting liquid level and flow into the same magnitude, defined as:

$$g ( x ) = \frac{x - {x}_{min}}{{x}_{max} - {x}_{min}} \qquad Formula 1 - 8$$

in the formula, x represents an observed value or a simulated value of a liquid level and/or a flow monitoring point;
xₘᵢₙ and xₘₐₓ represent an upper limit and a lower limit of the observed value or the simulated value of a liquid level and/or a flow monitoring point;
S23, adopting the genetic algorithm to solve a single-objective optimization model F(Q) of the subsystem flow optimization, and obtaining an optimal total sewage influent time series matrix Q of each subsystem.

S3, checking a sewage flow adjustment coefficient kₕ of each manhole node h of the sewage pipe network hydraulic model;
S31, establishing the single-objective function for flow optimization of the manhole node of the sewage pipe network hydraulic model, with the specific formula as follows:
Minimizing:

$$F ( K ) = {\sum }_{t = {T}_{w}}^{{T}_{e}} ( {\sum }_{i = 1}^{M} {[ g ( {w}_{i}^{o} ( t ) ) - g ( {w}_{i}^{s} ( t ) ) ]}^{2} + {\sum }_{n = 1}^{N} {[ g ( {f}_{n}^{o} ( t ) ) - g ( {f}_{n}^{s} ( t ) ]}^{2} ) \qquad Formula 1 - 9$$

$${MI}_{h}^{u} ( {t}_{a} ) = {k}_{h} \frac{{q}_{n} ( {t}_{a} ) \times P ( h )}{{\sum }_{h = 1}^{{H}_{n}} P ( h )} , \\ the manhole node h is associated with the residential buildings \qquad Formula 1 - 10$$

$${F}_{m} ( {MI}^{u} ( {t}_{a} ) ) = [ {W}^{s} ( {t}_{a} ) ; {f}^{s} ( {t}_{a} ) ] \qquad Formula 1 - 11$$

$${k}_{h} ∈ [ {k}_{min} , {k}_{max} ] \qquad Formula 1 - 12$$

where K=[k₁, k₂, . . . k_{H}]^{T} is a decision variable;
F(K) is an objective function value with K as a decision variable;
kₕ represents the flow adjustment coefficient for the manhole node h;
MIₕ^{u}(tₐ) is the sewage influent of the single manhole node h at the moment tₐ after being adjusted with kₕ;
MI^{u}(tₐ)is the sewage influent of all manhole nodes at the moment tₐ after being adjusted with K; and
kₘᵢₙ and kₘₐₓ represent the minimum value and the maximum value allowed by the flow adjustment coefficient for the manhole node, preferably kₘᵢₙ=0.85, and kₘₐₓ=1.15.
S32, adopting the evolutionary algorithm to solve a single-objective optimization model F(K) of the flow optimization of the manhole nodes in the sewage pipe network hydraulic model, and obtaining an optimal sewage flow adjustment coefficient kₕ for each manhole node h.

S4, realizing accurate building of the sewage pipe network hydraulic model and simulation of hydraulic parameters:
S41, obtaining the total population corresponding to the manhole nodes h as prior information through the step S1 according to the three-dimensional geographic information, and preliminarily checking the total sewage influent of the sewage pipe network subsystem according to the step S2;
S42, checking the sewage flow adjustment coefficient kₕ of each manhole node based on the total sewage influent of the subsystem obtained in the step S41 according to the step S3, and determining a single-day influent time series MIₕ^{u}(tₐ) of each manhole node; and
S43, running the sewage pipe network hydraulic model to simulate sewage pipe network hydraulic parameter values.

Preferably, the simulated sewage pipe network hydraulic parameter values include simulated liquid level, flow rate and other hydraulic parameters.

Practical application of the method in the present disclosure in engineering will be described below in the form of simulating actual examples, which do not represent realistic examples, but the illustration of these examples only indicates that the present disclosure can be applied to engineering practice and can obtain relevant technical effects.

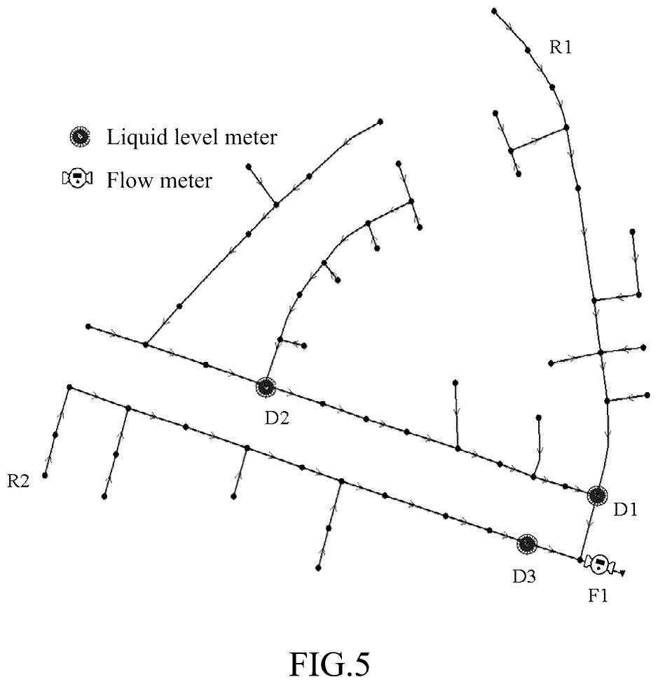

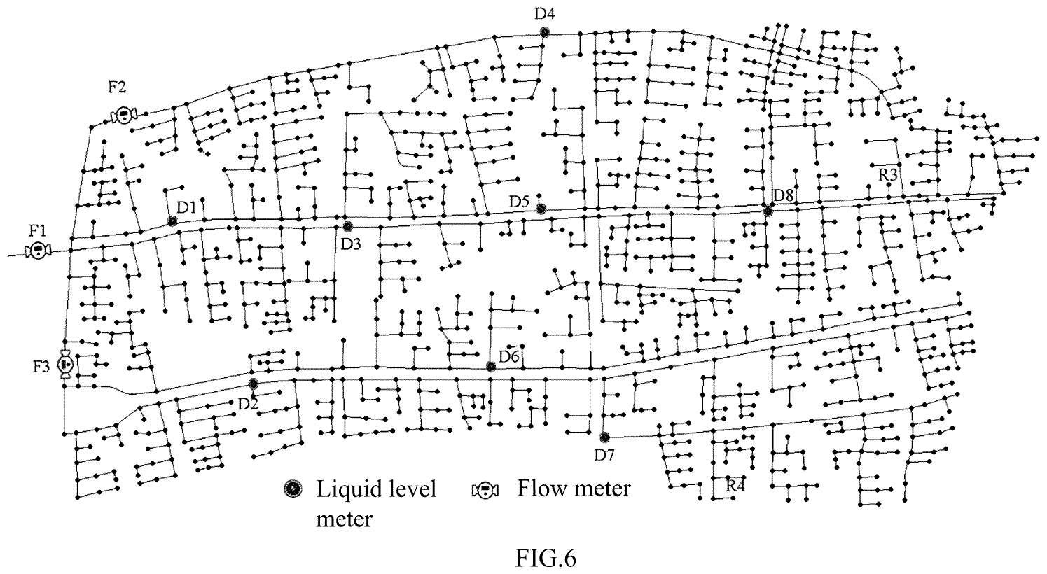

The sewage networks in the two cities of Benk and Xiuzhou will be taken as examples for illustration. The sewage network in Benk City (denoted as BKN) consists of 64 manhole nodes, 64 sewage pipes and a sewage outlet, the total length of the sewage pipes is approximately 9.4 kilometers, the sewage pipe slope is 0.65% on average, the total population in the area is about 20,500, and 3 liquid level meters and 1 flow meter (positions thereof are shown in FIG. 5) are installed in the BNK sewage pipe network; and the sewage network in Xiuzhou City (denoted as XZN) consists of 1,214 manhole nodes, 1,214 sewage pipes and a sewage outlet, the total length of the sewage pipes is approximately 86 kilometers, the sewage pipe slope is 0.27% on average, the total population in the area is about 107,500, and 8 liquid level meters and 3 flow meters are installed in the BNK sewage pipe network (positions thereof are shown in FIG. 6).

The BKN sewage pipe network and the XZN sewage pipe network have separate monitoring instruments that record historical data without rainfall for 31 days in a certain month. The time step is 30 minutes, and data of 1488(31×24×2) time steps are used for each monitoring points to perform simulation; the hot start time T_{w} of the sewage pipe network hydraulic model is 3 days, the hydraulic parameters are checked in the following 14 days, and the check results are verified in the final 14 days, where data of 1344(28×24×2) time steps are used for each monitoring point in the check-verification process. For the BKN case and the XZN case, the average populations η per building volume are 0.96 and 0.97 np/(100m³), the occupancy rates Aᵣ are both 100%, the conversion coefficients TFⱼ(t) between water consumption and sewage discharge volume are both 0.8, and the minimum value kₘₐₓ and the maximum value kₘᵢₙ of the flow adjustment coefficient for the manhole node are both 1.15 and 0.85. The two optimization stages of parameter check are calculated by using the Borg evolutionary algorithm, the population size is set to be 500, the maximum number of iterations is set to be 100000, and other parameters adopt default values.

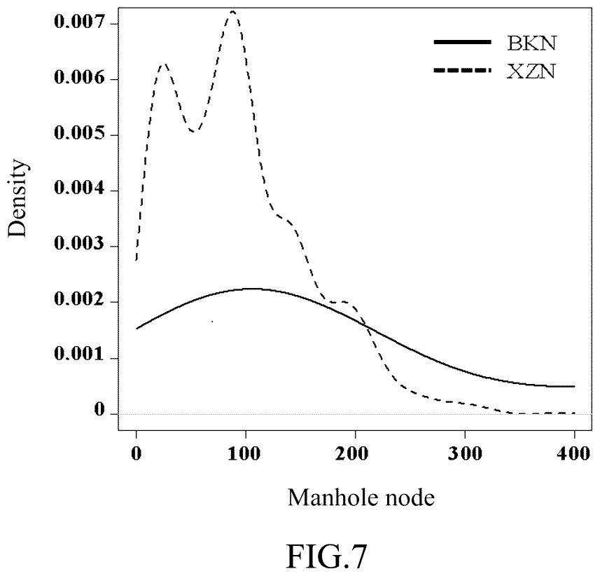

FIG. 7 illustrates the density distribution of the population associated with the manhole nodes in the two cases.

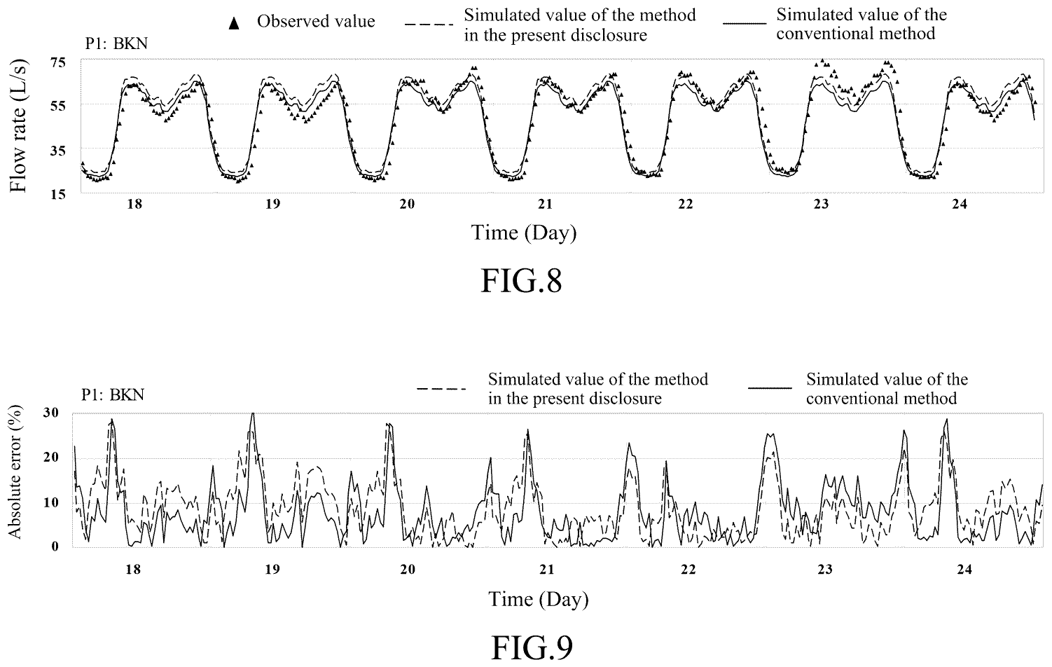

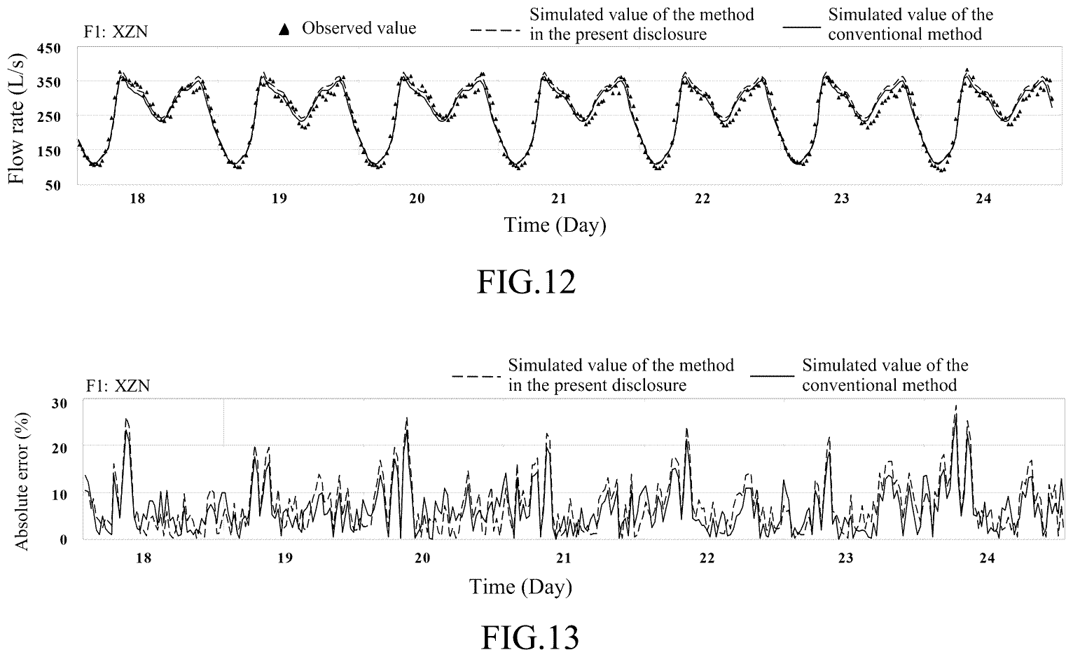

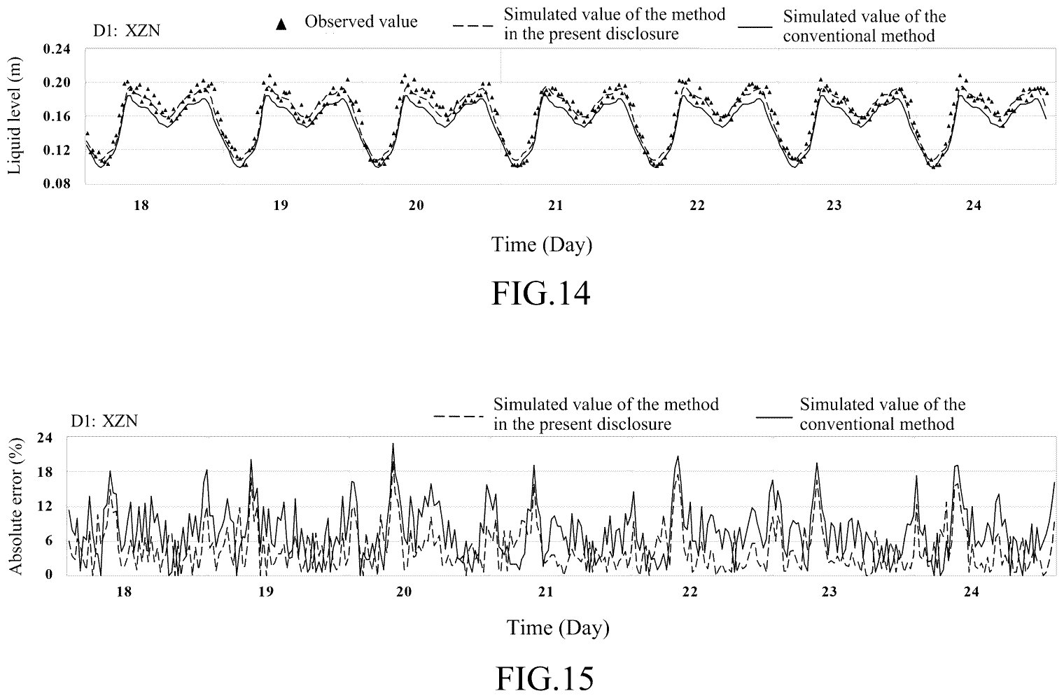

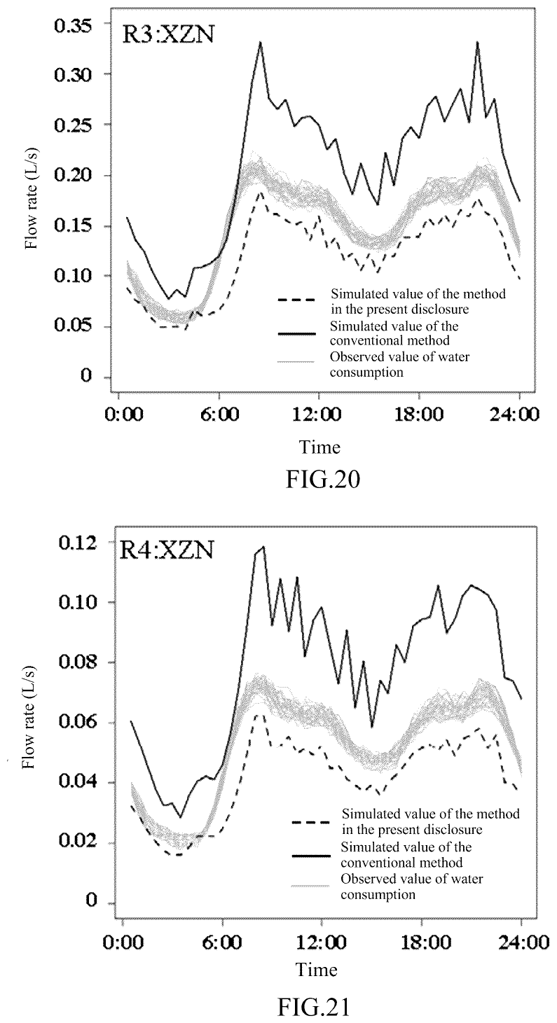

FIGS. 8-23 illustrate the simulation results of the verification stage for BKN and XZN cases. In order to evaluate the effect, the results of the method in the present disclosure were compared with the conventional method. Considering the difficulty of information acquisition, the conventional method in the following embodiments selects the pipe length as the prior information for calculation, and the other parts are the same as the method in the present disclosure (that is, both of the methods adopt the two-stage optimization steps and the identical parameter settings, except for the prior information).

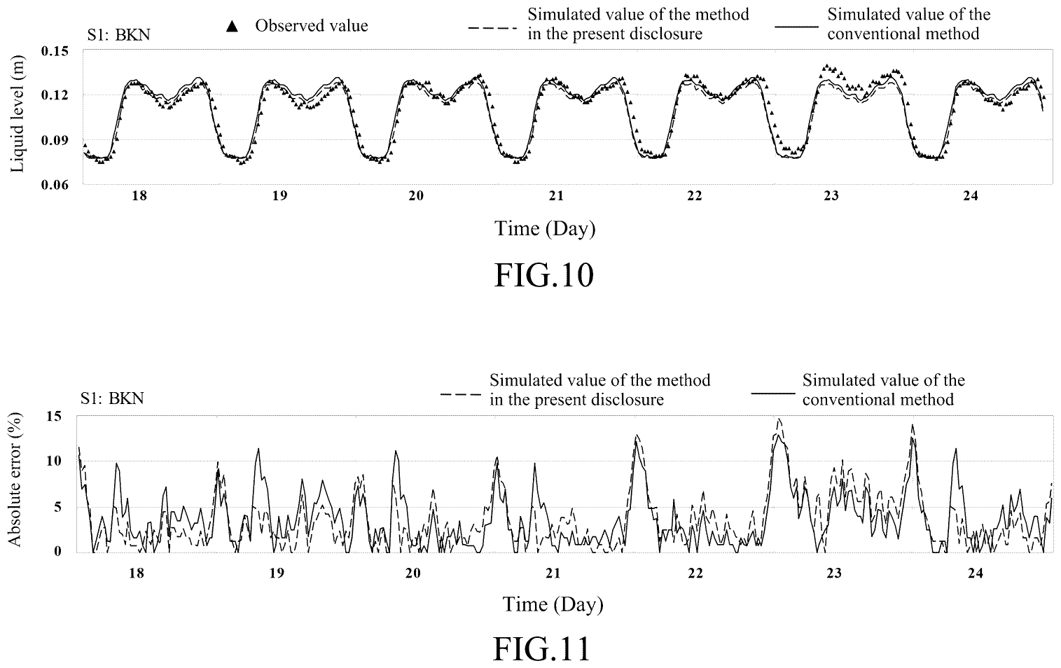

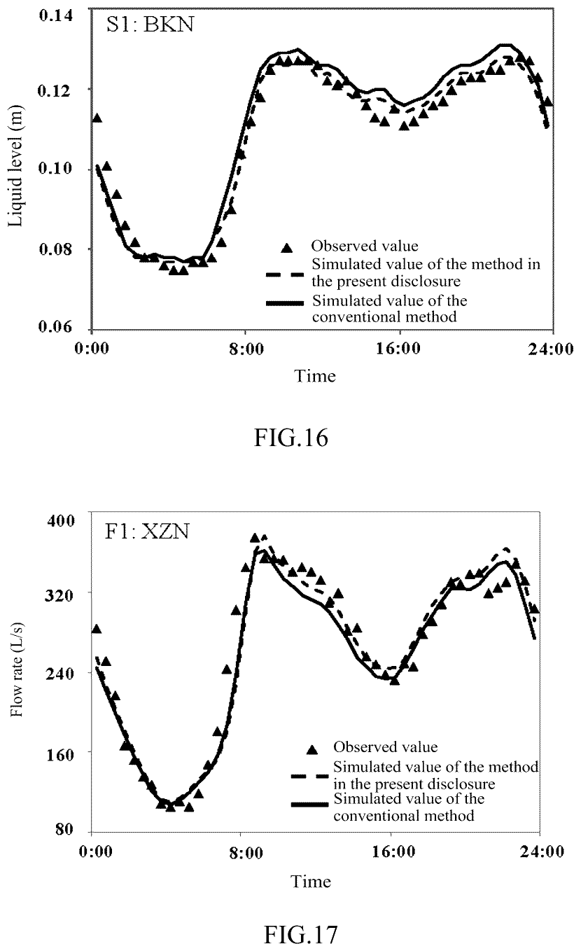

As shown in FIGS. 8-15, the observed values of the monitoring points of BKN and XZN are directly compared with the simulated values of the two methods, and absolute errors thereof, one flow monitoring point and one liquid level monitoring point are selected for each case as the example, data of 7 days at the verification stage are selected, and data of the 18^{th} and 24^{th} days are selected for comparison; as shown in FIGS. 8-9, for the flow monitoring points of the BKN case, the mean absolute error value between the method in the present disclosure and the observed value is 8.78%, while the same of the conventional method is 9.67%; as shown in FIGS. 10-11, for the liquid level monitoring points of the BKN case, the mean absolute error values between the method in the present disclosure and the conventional method are 3.57% and 3.63%, respectively. For XZN cases, the mean absolute error values of the simulated flow values between the method in the present disclosure and the conventional method are 6.29% and 6.46%, respectively, and the mean absolute error values of the liquid level values between the method in the present disclosure and the conventional method are 4.50% and 7.60%, respectively; as shown in FIGS. 16-17, it can be seen from the comparison between the two methods of the simulated values and the observed values on a certain day (verification stage) of two monitoring points that the simulated value of the method in the present disclosure are closer to the real observed values than the conventional method.

In order to perform an overall evaluation of the simulation conditions of all monitoring points, coefficient of determination R², Nash-Sutcliffe efficiency coefficient (NSE) and Kling-Gupta efficiency coefficient (KGE) of all monitoring points are identified, as shown in Tables 1-2.

It can be seen that, for the BKN case, the evaluation results of the two methods are less different; for the XZN cases, the evaluation result of the method in the present disclosure is superior to that of the conventional method, and for D1-D5 monitoring points of the XZN case, the NSE value of the conventional method is obviously lower (lower than 0.8), while the result of the method in the present disclosure remains excellent (higher than 0.85), which proves that the hydraulic simulation effects of monitoring points of the large-scale pipe network in the method in the present disclosure are superior to those of the conventional method.

TABLE 1
Evaluation of Simulation Results of
Monitoring Points in the BKN Case

| Monitoring | Conventional method | | | Method of the present disclosure | | |
|---|---|---|---|---|---|---|
| point | R² | NSE | KGE | R² | NSE | KGE |
| S1 | 0.92 | 0.92 | 0.96 | 0.93 | 0.92 | 0.95 |
| S2 | 0.91 | 0.89 | 0.90 | 0.92 | 0.90 | 0.91 |
| S3 | 0.88 | 0.87 | 0.80 | 0.90 | 0.87 | 0.78 |
| P1 | 0.91 | 0.91 | 0.92 | 0.92 | 0.91 | 0.94 |
| Mean | 0.91 | 0.89 | 0.89 | 0.92 | 0.90 | 0.89 |

TABLE 2
Evaluation of Simulation Results of
Monitoring Points in the XZN Case

| Monitoring | Conventional method | | | Method of the present disclosure | | |
|---|---|---|---|---|---|---|
| point | R² | NSE | KGE | R² | NSE | KGE |
| D1 | 0.91 | 0.73 | 0.85 | 0.90 | 0.90 | 0.93 |
| D2 | 0.92 | 0.70 | 0.82 | 0.92 | 0.89 | 0.89 |
| D3 | 0.90 | 0.74 | 0.88 | 0.89 | 0.88 | 0.94 |
| D4 | 0.93 | 0.73 | 0.82 | 0.93 | 0.92 | 0.91 |
| D5 | 0.90 | 0.68 | 0.81 | 0.89 | 0.89 | 0.91 |
| D6 | 0.91 | 0.82 | 0.88 | 0.90 | 0.89 | 0.92 |
| D7 | 0.90 | 0.86 | 0.86 | 0.90 | 0.90 | 0.90 |
| D8 | 0.88 | 0.86 | 0.93 | 0.86 | 0.85 | 0.92 |
| F1 | 0.94 | 0.94 | 0.96 | 0.93 | 0.92 | 0.95 |
| F2 | 0.95 | 0.96 | 0.95 | 0.96 | 0.96 | 0.96 |
| F3 | 0.93 | 0.94 | 0.95 | 0.93 | 0.93 | 0.96 |
| Mean | 0.92 | 0.81 | 0.88 | 0.91 | 0.90 | 0.93 |

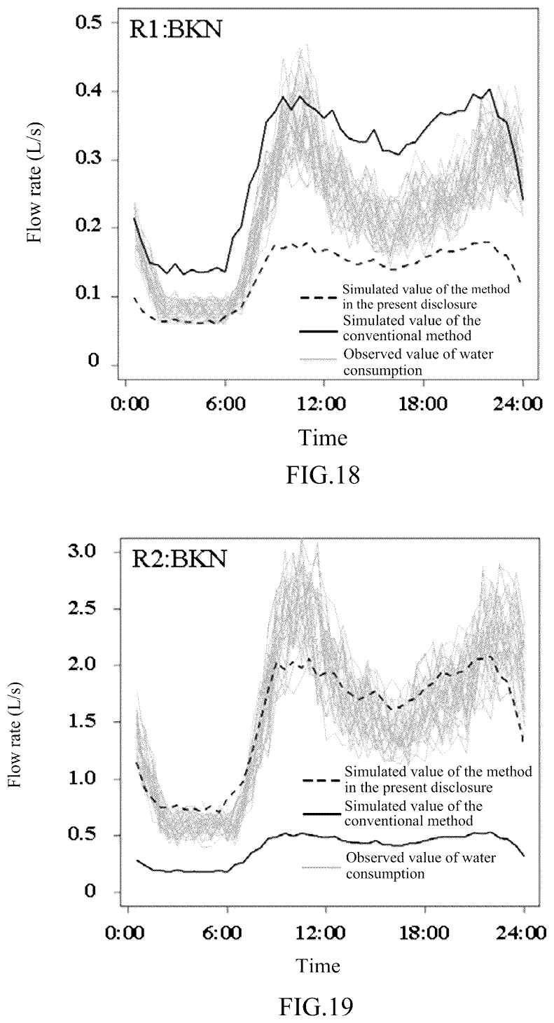

As shown in FIGS. 18-21, the simulation effects of the non- monitoring points of the BKN and XZN cases are compared, and due to the lack of direct observation data of the non-monitoring points, the data of intelligent water meters of the water supply nodes are adopted as standards for performing comparison. According to engineering experience, the sewage flow value should be about 80% of the water consumption of its associated water supply nodes. As can be seen from FIGS. 18-21, the simulated values of the conventional method at R1, R3, and R4 are always greater than the water consumption data, while the simulated value at R2 is significantly lower than the water consumption data, both of which are inconsistent with actual engineering experience. On the contrary, the sewage flows value simulated by the method in the present disclosure are slightly lower that the corresponding water consumption data, which is consistent with the engineering practice, indicating that the method in the present disclosure can more accurately simulate hydraulic variables at the manhole nodes without a liquid level meter or a flow meter.

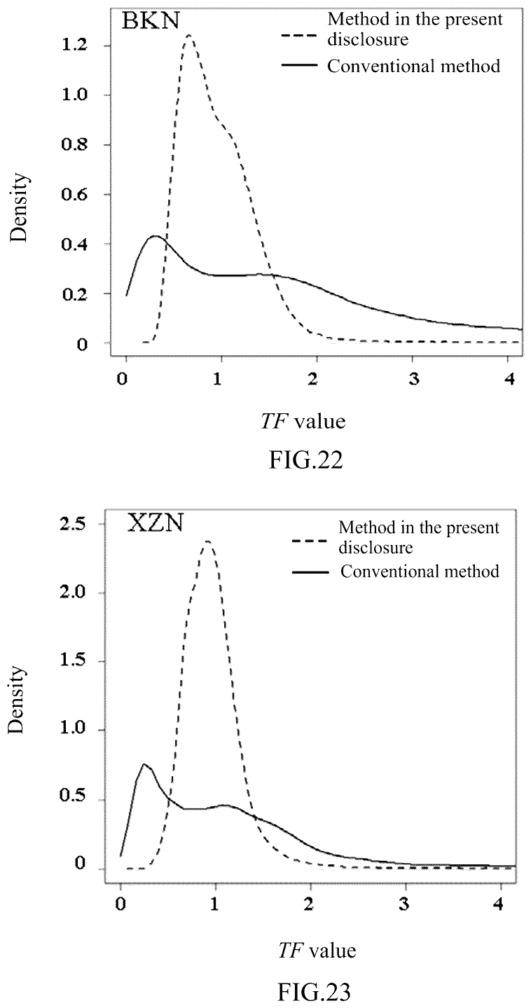

As shown in FIGS. 22-23, the distribution of the water consumption and the sewage discharge conversion coefficient TF of the manhole nodes having the water consumption data corresponding to the water supply nodes is statistically identified. It can be seen that the TF values of the conventional method are dispersedly distributed in the parts far lower than 1 and far greater than 1, which is inconsistent with the actual situation; while the TF values of the method in the present disclosure are intensively distributed in the parts slightly lower than 1, which is consistent with the engineering practice, indicating that the method in the present disclosure can effectively solve the multi-solution problem and can accurately simulate the sewage hydraulic parameters at the positions without monitoring information.

Therefore, by means of the sewage pipe network hydraulic model building method based on three-dimensional geographic information provided in the present disclosure, the three-dimensional map is adopted to estimate the population corresponding to the buildings and establish the physical connection between the buildings and the sewage manhole nodes, which provides prior information for checking the sewage pipe network hydraulic model without sufficient monitoring information, the total influent flow of the sewage pipe network and the flow adjustment coefficient of each manhole node are determined by using a two-step optimization method, accurate simulation of the liquid level and flow parameters of the entire sewage pipe network is achieved, the multi-solution problem arising from the check of the sewage pipe network is solved, thereby providing important technical support for solving such problems as pipe blockage, pipe leakage, rainwater and sewage misconnection, illegal discharge, and sewage overflow, and having practical engineering application value.

Although the preferred embodiments of the present disclosure have been described, additional alterations and modifications to those embodiments may be made by those skilled in the art once the basic inventive concept is apparent to those skilled in the art. Therefore, the appended claims are intended to be interpreted as including the preferential embodiments and all changes and modifications falling within the scope of the present disclosure.

What is claimed is:

1. A sewage pipe network hydraulic model building method based on three-dimensional geographic information, wherein the method comprises:
(1) estimating the total population P(h) corresponding to the sewage manhole node h;
(2) checking the total sewage influent qₙ(tₐ) of a sewage pipe network hydraulic model subsystem at each moment tₐ;
(3) checking a sewage flow adjustment coefficient kₕ of each manhole node h of the sewage pipe network hydraulic model; and
(4) realizing accurate building of the sewage pipe network hydraulic model and simulation of hydraulic parameters of the sewage pipe network.

2. The sewage pipe network hydraulic model building method based on three-dimensional geographic information according to claim 1, wherein the step (1) specifically comprises:
(11) preliminarily building a sewage pipe network hydraulic model based on a topological structure of the sewage pipe network and physical information of component members thereof;
(12) further establishing the physical mapping relation between the manhole nodes h of the sewage pipe network hydraulic model and surrounding buildings based on the three-dimensional geographic information, as shown in FIG. 2, and mapping each building the manhole node h with the closest spatial distance according to the Euclidean distance formula, with the specific formula as follows:
d(r,h)=\sqrt{(xₕ−xᵣ)²+(yₕ−yᵣ)²+(zₕ−zᵣ)²} Formula 1-1
wherein (xᵣ, yᵣ, zᵣ) is a three-dimensional coordinate of a plane geometric center coordinate system based on a bottom surface of a building;
(xₕ, yₕ, zₕ) is a three-dimensional coordinate of a coordinate system based on the manhole mouth of the manhole node h;
(13) dividing all buildings into residential buildings r and public buildings u according to the functionality, and estimating the total population of all residential buildings r corresponding to the manhole node h, with the specific formula as follows:
$$P ( h ) = {A}_{r} {\sum }_{r = 1}^{{R}_{h}} η \times {V}_{r} ( h ) \qquad Formula 1 - 2$$
wherein P(h) is the total population estimate associated with the manhole node h;
Vᵣ(h) is the volume (in m³) of the residential building r associated with the manhole node h;
Rₕ is the number of all residential buildings r associated with the manhole node h;
η is the average population per building volume (in np/m³);
Aᵣ is the occupancy rate of the residential building r;
(14) estimating the sewage discharge volume of all public buildings u corresponding to the manhole node h, with the specific formula as follows:
DSᵤ(t)=TFᵤ(t)×WSᵤ(t) Formula 1-3
wherein DSᵤ(t) is the sewage discharge volume of the public building u at a moment t;
WSᵤ(t) is the water consumption of the public building u at the moment t; and
TFᵤ(t) is a conversion coefficient between water consumption and sewage discharge volume at the moment t.

3. The sewage pipe network hydraulic model building method based on three-dimensional geographic information according to claim 2, wherein the component members comprise a sewage pipeline, manhole nodes h and a sewage outlet.

4. The sewage pipe network hydraulic model building method based on three-dimensional geographic information according to claim 1, wherein the step (2) specifically comprises:
(21) dividing the sewage pipe network into N subsystems based on the positions of the installed N sewage flow meters, wherein each subsystem has a unique sewage flow meter corresponding to the subsystem area, and N flow monitoring points are provided, wherein N only represents the number and has no practical significance;
(22) establishing a single-objective function of the subsystem flow optimization, with the specific formula as follows:
minimizing:
$$Formula 1 - 4$$
$$F ( Q ) = {\sum }_{t = {T}_{w}}^{{T}_{e}} ( {\sum }_{i = 1}^{M} {[ g ( {w}_{i}^{o} ( t ) ) - g ( {w}_{i}^{s} ( t ) ) ]}^{2} + {\sum }_{n = 1}^{N} {[ g ( {f}_{n}^{o} ( t ) ) - g ( {f}_{n}^{s} ( t ) ]}^{2} )$$
$$where Q = [ \begin{matrix}{q}_{1} ( Δ t ) , {q}_{1} ( 2 Δ t ) , ... , {q}_{1} ( T ) \\ {q}_{2} ( Δ t ) , {q}_{2} ( 2 Δ t ) , ... , {q}_{2} ( T ) \\ ... \\ {q}_{N} ( Δ t ) , {q}_{N} ( 2 Δ t ) , ... , {q}_{N} ( T )\end{matrix} ] ; \qquad Formula 1 - 5$$
$$Formula 1 - 6$$
$${MI}_{h} ( {t}_{a} ) = \{ \begin{matrix}\frac{{q}_{n} ( {t}_{a} ) \times P ( h )}{{\sum }_{h = 1}^{{H}_{n}} P ( h )} , h ∈ {H}_{n} , & when the manhole h is associated \\ & with the residential building \\ {\sum }_{u = 1}^{h ( u )} {DS}_{u} ( {t}_{a} ) , & when the manhole node h is \\ & associated with the public building\end{matrix}$$
$${F}_{m} ( MI ( {t}_{a} ) ) = [ {W}^{s} ( {t}_{a} ) ; {f}^{s} ( {t}_{a} ) ] = [ {w}_{1}^{s} ( {t}_{a} ) , {w}_{2}^{s} ( {t}_{a} ) , ... , {w}_{M}^{s} ( {t}_{a} ) ; {f}_{1}^{s} ( {t}_{a} ) , {f}_{2}^{s} ( {t}_{a} ) , ... , {f}_{N}^{s} ( {t}_{a} ) ] \qquad Formula 1 - 7$$
wherein MIₕ(tₐ) is the sewage influent of a single manhole node h at the moment tₐ;
MI(tₐ) is the sewage influent of all manhole nodes at the moment tₐ;
qₙ(T) is the total sewage influent of all manhole nodes of the n^{th} subsystem at the moment T, wherein N is 1,2,3, and N;
Hₙ are all manhole nodes associated with the residential building in the subsystem;
Fₘ(MI(tₐ)) is a hydraulic simulation result of the sewage pipe network based on MI(tₐ), comprising the liquid level of a manhole node and the flow rate of a sewage pipe;
Tₑ represents the end time of the liquid levels and flow monitoring values used for checking the sewage pipe network hydraulic model;
T_{w} represents the starting time for checking the sewage pipe network hydraulic model;
tₐ is the check moment selected by the sewage pipe network hydraulic model;
Q is a decision variable matrix which represents a time series matrix of the total sewage influent rate of each subsystem;
i=1, 2, . . . , M, wherein M represents the number of liquid level monitoring points;
n=1, 2, . . . , N, wherein N represents the number of flow monitoring points corresponding to the subsystems one by one;
F(Q) is an objective function value with Q as a decision variable;
T is a simulation period of the sewage pipe network hydraulic model;
Δt is a calculation time accuracy of the sewage pipe network hydraulic model;
wᵢ^{s}(tₐ) and fₙ^{s}(tₐ) respectively represent simulated liquid level values at a node i of the manhole node with liquid level monitoring and simulated flow values of a sewage pipe n with flow monitoring at the moment ta ;
wᵢ^{o}(t) and fₙ^{o}(t) respectively represent monitoring values at a node i of the manhole node with liquid level monitoring and monitoring values of a sewage pipe n with flow monitoring at the moment;
w^{s}(tₐ) and f^{s}(tₐ) respectively represent a collection of the simulated liquid level values at the node i of the manhole node with liquid level monitoring and a collection of the simulated flow values of the sewage pipe with flow monitoring at the moment tₐ;
h(u) represents the total number of public buildings associated with the sewage manhole node h;
g( ) is a linear conversion function for converting liquid level and flow into the same magnitude, defined as:
$$g ( x ) = \frac{x - {x}_{min}}{{x}_{max} - {x}_{min}} \qquad Formula 1 - 8$$
in the formula, x represents an observed value or a simulated value of a liquid level and/or a flow monitoring point;
xₘᵢₙ and xₘₐₓ represent an upper limit and a lower limit of the observed value or the simulated value of a liquid level and/or a flow monitoring point; and
(23) adopting the genetic algorithm to solve a single-objective optimization model F(Q) of the subsystem flow optimization, and obtaining an optimal total sewage influent time series matrix Q of each subsystem.

5. The sewage pipe network hydraulic model building method based on three-dimensional geographic information according to claim 1, wherein the step (3) specifically comprises:
(31) establishing the single-objective function for flow optimization of the manhole node of the sewage pipe network hydraulic model, with the specific formula as follows:
minimizing:
$$F ( K ) = {\sum }_{t = {T}_{w}}^{{T}_{e}} ( {\sum }_{i = 1}^{M} {[ g ( {w}_{i}^{o} ( t ) ) - g ( {w}_{i}^{s} ( t ) ) ]}^{2} + {\sum }_{n = 1}^{N} {[ g ( {f}_{n}^{o} ( t ) ) - g ( {f}_{n}^{s} ( t ) ]}^{2} ) \qquad Formula 1 - 9$$
$${MI}_{h}^{u} ( {t}_{a} ) = {k}_{h} \frac{{q}_{n} ( {t}_{a} ) \times P ( h )}{{\sum }_{h = 1}^{{H}_{n}} P ( h )} , \\ the manhole node h is associated with the residential buildings \qquad Formula 1 - 10$$
$${F}_{m} ( {MI}^{u} ( {t}_{a} ) ) = [ {W}^{s} ( {t}_{a} ) ; {f}^{s} ( {t}_{a} ) ] \qquad Formula 1 - 11$$
$${k}_{h} ∈ [ {k}_{min} , {k}_{max} ] \qquad Formula 1 - 12$$
wherein K=[k₁, k₂, . . . k_{H}]^{T} is a decision variable;
F(K) is an objective function value with K as a decision variable;
kₕ represents the flow adjustment coefficient for the manhole node h;
MIₕ^{u}(tₐ) is the sewage influent of the single manhole node h at the moment tₐ after being adjusted with kₕ;
MI^{u}(tₐ) is the sewage influent of all manhole nodes at the moment ta after being adjusted with K; and
kₘᵢₙ and kₘₐₓ represent the minimum value and the maximum value allowed by the flow adjustment coefficient for the manhole node; and
(32) adopting the evolutionary algorithm to solve a single-objective optimization model F(K) of the flow optimization of the manhole nodes in the sewage pipe network hydraulic model, and obtaining an optimal sewage flow adjustment coefficient kₕ for each manhole node h.

6. The sewage pipe network hydraulic model building method based on three-dimensional geographic information according to claim 1, wherein the step (4) specifically comprises:
(41) obtaining the total population corresponding to the manhole nodes h as prior information through the step (1) according to the three-dimensional geographic information, and preliminarily checking the total sewage influent of the sewage pipe network subsystem according to the step (2);
(42) checking the sewage flow adjustment coefficient kₕ of each manhole node based on the total sewage influent of the subsystem obtained in the step (41) according to the step (3), and determining a single-day influent time series MIₕ^{u}(tₐ) of each manhole node; and
(43) running the sewage pipe network hydraulic model to simulate sewage pipe network hydraulic parameter values.
